(19) United States
(12) Patent Application Publication
(10) Pub. No.: US 2020/0222733 A1
(43) Pub. Date: Jul. 16, 2020

(54) Mitigation Device

(71) Applicant: William Link, Pine, CO (US)

(72) Inventor: William Link, Pine, CO (US)

(21) Appl. No.: 16/735,178

(22) Filed: Jan. 6, 2020

Related U.S. Application Data
(60) Provisional application No. 62/790,562, filed on Jan. 10, 2019.

(51) Int. Cl. A62C 2/04; A01D 7/02

(52) U.S. Cl. CPC A62C 2/04; A01D 7/02

(57) ABSTRACT

An example mitigation device includes a spine having a first support and a second support, the first support and the second support are substantially rectangular with semicircular ends. A plurality of linear tines sandwiched between the first support and the second support and extending in two opposite directions from the spine. A socket on the spine to receive a handle. In an example, each of the tines extend about one-third the length of the tine on a first side of the spine, and each of the tines extend about two-thirds the length of the tine on a second side of the spine. In an example, the tines are substantially perpendicular to the socket and the handle and configured to support the handle in a substantially upright position perpendicular to the ground when the tines are laid substantially flat on the ground.

### PRIORITY CLAIM

This application claims the priority benefit of U.S. Provisional Patent Application No. 62/790,562 filed Jan. 10, 2019 for “Mitigation Device” of William Link, hereby incorporated by reference in its entirety as though fully set forth herein.

### BACKGROUND

Forest fires appear to have become more common in recent years, and more disastrous when they do strike. Dried undergrowth provides fuel for fires, and is partly to blame. The number and severity of forest fires can be reduced by maintaining healthy ecosystems, to alleviate and reduce hazardous fuel sources through mitigation pertaining to forest fires. However, many areas are difficult to manage with heavy equipment, and therefore go largely unmanaged.

The traditional method of clearing ground fuels and litter is to use a typical garden or leaf rake. The problem with using a typical garden or leaf rake for this task is that it can clog up very quickly with leaves, pine needles, pine cones, and other small matter. This necessitates clearing by hand every few minutes in order to continue working.

### BRIEF DESCRIPTION OF THE DRAWINGS

FIG. 1 is a perspective view of an example mitigation device.

FIG. 2 is a front view of the example mitigation device, wherein the rear view is a mirror image.

FIG. 3 is a top view of the example mitigation device, wherein the bottom view is a mirror image.

FIG. 4 is a right side view of the example mitigation device, wherein the left side view is a mirror image.

### DETAILED DESCRIPTION

In an example, the mitigation device disclosed herein may be implemented as an effective management tool to maintain the health of various ecosystems, to alleviate and reduce hazardous ground fuels and litter that feed wildfires through mitigation pertaining to forest fires, while simultaneously aerating the soil in areas that are difficult to manage with other hand tools or with larger equipment. The mitigation device does not clog with pine needles, leaves, twigs, cones or other ground duff, and thus can be implemented to remove ground fuels faster and more efficiently than tools currently on the market.

The mitigation device is suitable for professional firefighting and forestry uses, but can also be used by the homeowner (e.g., for gardening and lawn care). There is no limited as to end-use or end-user. The example mitigation device is a utility tool that can be used by homeowners, residents, schools, rural and urban parks, trails and by environmental and conservation groups, State, Federal and Tribal agencies for open space and wildland/urban interface areas, to name a few example end-users of the device. The mitigation device can be used in grassland, marshes, watershed restoration, savannas, palm forests, sagebrush, desert lands, shrub lands, boreal, tropical and temperate forests, to name only a few examples.

Before continuing, it is noted that as used herein, the terms “includes” and “including” mean, but is not limited to, “includes” or “including” and “includes at least” or “including at least.” The term “based on” means “based on” and “based at least in part on.”

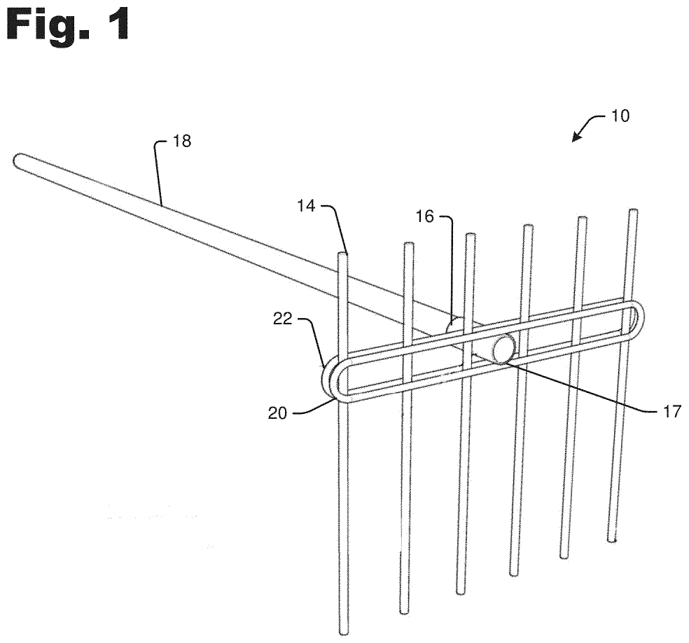

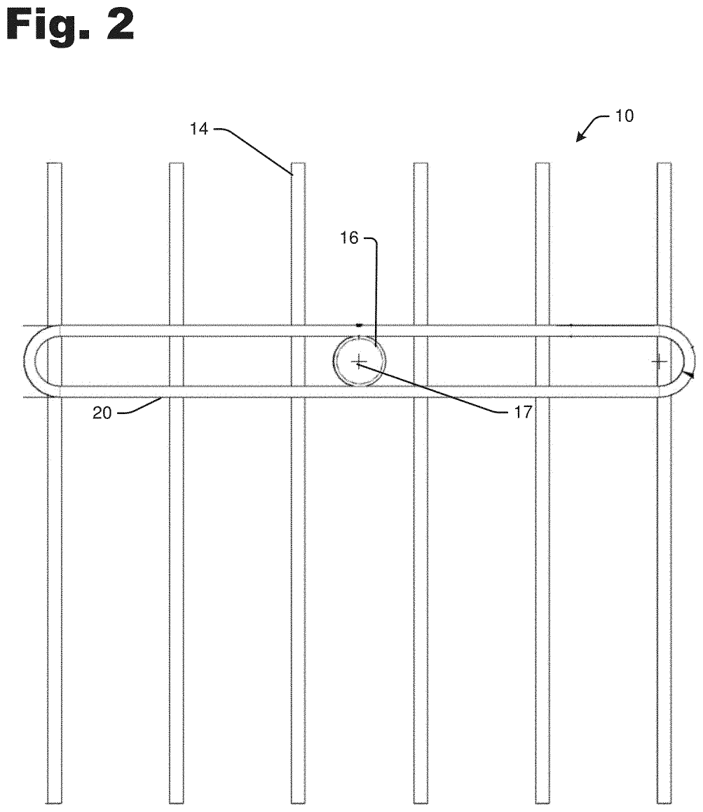

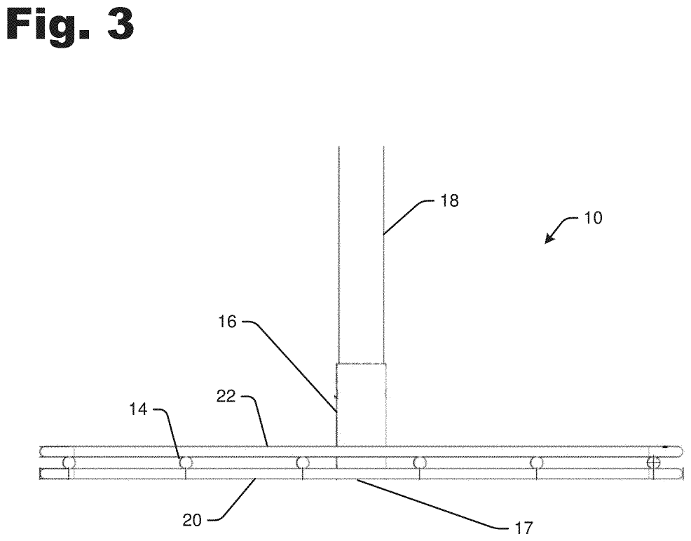

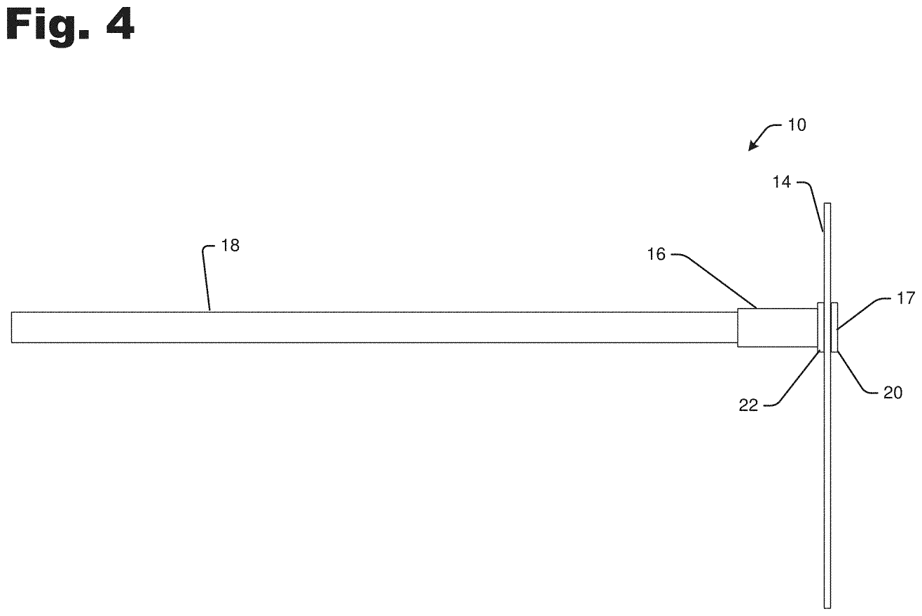

FIG. 1 is a perspective view of an example mitigation device 10. FIG. 2 is a front view of the example mitigation device 10, wherein the rear view is a mirror image. FIG. 3 is a top view of the example mitigation device 10, wherein the bottom view is a mirror image of the top view. FIG. 4 is a right side view of the example mitigation device 10, wherein the left side view is a mirror image of the right side view.

An example of the mitigation device 10 includes a spine 12, and a plurality of linear tines 14 extending in two opposite directions from the spine 12. The mitigation device 10 also includes a socket 16 on the spine 12 to receive a handle 18. In an example, the handle has a diameter of about one and one-eighth inch, and is about 60 inches long.

In the example shown, the mitigation device 10 has six tines 14 with three tines 14 on each side of the socket 16. In another example, the mitigation device 10 has ten tines 14 with five tines 14 on each side of the socket 16. However, the mitigation device 10 is not limited to any number of tines 14, and can have more or less tines 14. In an example, the tines 14 are cold rolled steal having a diameter of about one-quarter to five-sixteenth of an inch. The tines 14 may be spaced about three inches part from one another on the spine. However, the tines may be spaced at other distances that are greater than or less than three inches.

In the example shown, each of the tines 14 extend about one-third the length of the tine 14 on a first side (e.g., top as shown in FIG. 1) of the spine 12. For example, the tines 14 may extend about 4 inches above the spine 12. Each of the tines 14 also extend about two-thirds the length of the tine on a second side (e.g., bottom as shown in FIG. 1) of the spine 12. For example, the tines 14 may extend about 10 inches below the spine 12.

In an example, the head of the mitigation device is configured to stand upright on its own; there is no need to lean it against a wall or other object. This is considered a built-in safety feature that allows the mitigation device to stand upright on its own. That is, when stored in the upright position, the tines do not create a tripping or falling hazard.

In an example, the tines 14 are substantially perpendicular to the socket 16 and the handle 18 and configured to support the handle 18 in a substantially upright position perpendicular to the ground when the tines are laid substantially flat on the ground. For example, the overall length and/or the proportion of the length of the tines 14 on either side of the spine 12 may be selected to balance the handle in the upright position. Likewise, the nose 17 of the socket may be substantially level with or recessed slightly relative to the spine 12 so that the tines lay substantially flat on the ground with the handle 18 in the upright position.

In an example, the spine 12 includes a first support 20 mounted on a first side (e.g., front as shown in FIG. 1) of the tines 14. The spine 12 also includes a second support 22 mounted on a second side (e.g., back as shown in FIG. 1) of the tines 14. The tines 14 are sandwiched between the first support 20 and the second support 22 of the spine 12.

In an example, the first support 20 of the spine 12 is substantially rectangular with semicircular ends. For example, the rectangle may have a width of about one and three-quarters of an inch, and a length of about one foot and four-and-one-half inches. For example, the semicircular ends of the first support 20 may have a curvature radius of about five-eighths of an inch to about seven-eighths of an inch. The second support 22 of the spine 12 is also substantially rectangular with semicircular ends. For example, the semicircular ends of the second support 22 may have a curvature radius of between about five-eighths of an inch (e.g., inner diameter) and about seven-eighths of an inch (e.g., outer diameter).

In an example, the mitigation device 10 is inexpensive to produce. The mitigation device 10 is lightweight and can be readily transported to remote areas and used where heavy equipment may not be able to access. As such, the mitigation device 10 can be implemented in management and abatement of forest fire fuels and other natural disasters in various ecosystems by aiding in the removal of slash, debris, duff, and shed vegetation to effectively accomplish vegetation management, and the removal of float barriers on oil spills, to name only a few examples.

It is noted that the examples shown and described herein are provided for purposes of illustration, and are not intended to be limiting. Other devices and/or device configurations may be utilized to carry out the operations described herein.

In example operations, the components and connections depicted in the figures may be used. The operations described herein are provided to illustrate example implementations. It is noted that the operations are not limited to the ordering shown. Still other operations may also be implemented.

In use, the tool may be held at about a 45-degree angle relative to the ground, and lightly operated or “jiggled” in a front-to-back motion. The ground debris begins to gather together into a cluster that rolls upon itself. As the user steps backward and continues the motion, the bundle of debris gathers together in a pile. There is no need to apply pressure or use a traditional “raking” movement.

The mitigation device can be implemented to effectively remove litter as small as pine needles and as large as fallen tree branches with little physical effort. The piles of debris gathered by mitigation device can be lifted into a receptacle using the long tines, eliminating the need for a second tool like a shovel.

The unique design also enables aerating the soil simultaneously while it is gathering ground materials. The mitigation device may also be implemented to remove dead plants from the ground without harming living plants in the work area so that it can be used over and around living plants without harming them. This makes the mitigation device effective for clearing weeds, rocks, and other unwanted debris from garden beds and under or around bushes and larger plants.

It is noted that the examples shown and described are provided for purposes of illustration and are not intended to be limiting. Still other examples are also contemplated.

1. A mitigation device, comprising:
a spine;
a plurality of linear tines extending in two opposite directions from the spine, wherein the tines extend a greater distance from a first side of the spine and a lesser distance from a second side of the spine; and
a socket on the spine to receive a handle.

2. The mitigation device of claim 1, wherein each of the tines extend about one-third the length of the tine on a first side of the spine.

3. The mitigation device of claim 2, wherein each of the tines extend about two-thirds the length of the tine on a second side of the spine.

4. The mitigation device of claim 1, wherein the spine includes a first support mounted on a first side of the tines.

5. The mitigation device of claim 4, wherein the spine includes a second support mounted on a second side of the tines.

6. The mitigation device of claim 5, wherein the tines are sandwiched between the first support and the second support.

7. The mitigation device of claim 5, wherein the first support of the spine is substantially rectangular with semicircular ends.

8. The mitigation device of claim 5, wherein the semicircular ends of the first support have a curvature radius of about five-eighths of an inch to about seven-eighths of an inch.

9. The mitigation device of claim 5, wherein the second support of the spine is substantially rectangular with semicircular ends.

10. The mitigation device of claim 9, wherein the semicircular ends of the second support have a curvature radius of about five-eighths of an inch to about seven-eighths of an inch.

11. The mitigation device of claim 1, wherein the tines are substantially perpendicular to the socket and the handle.

12. The mitigation device of claim 1, further comprising six tines, three on each side of the handle.

13. The mitigation device of claim 1, further comprising ten tines, five on each side of the handle.

14. The mitigation device of claim 1, wherein the tines are spaced about 3 inches part from one another on the spine.

15. A mitigation device, comprising:
a spine having a first support and a second support;
a plurality of linear tines sandwiched between the first support and the second support and extending in two opposite directions from the spine; and
a socket on the spine to receive a handle.

16. The mitigation device of claim 15, wherein each of the tines extend about one-third the length of the tine on a first side of the spine, and wherein each of the tines extend about two-thirds he length of the tine on a second side of the spine.

17. The mitigation device of claim 15, wherein the first support and the second support are substantially rectangular with semi-circular ends having a curvature radius of about seven-eighths of an inch.

18. The mitigation device of claim 15, wherein the tines are substantially perpendicular to the socket and the handle and configured to support the handle in a substantially upright position perpendicular to the ground when the tines are laid substantially flat on the ground.

19. A mitigation device, comprising:
a spine having a first support and a second support, the first support and the second support are substantially rectangular with semicircular ends;
a plurality of linear tines sandwiched between the first support and the second support and extending in two opposite directions from the spine; and
a socket on the spine to receive a handle;
wherein each of the tines extend about one-third the length of the tine on a first side of the spine, and wherein each of the tines extend about two-thirds the length of the tine on a second side of the spine.

20. The mitigation device of claim 19, wherein the tines are substantially perpendicular to the socket and the handle and configured to support the handle in a substantially upright position perpendicular to the ground when the tines are laid substantially flat on the ground.
